(19) United States
(12) Patent Application Publication
(10) Pub. No.: US 2013/0006570 A1
(43) Pub. Date: Jan. 3, 2013

(54) UNBOUND OSCILLOSCOPE PROBE SYSTEMS-USING RF AND OR OPTICAL TEST POINT LINKS - PROVIDES OPERATIONAL ACCESS AND MOBILITY

(76) Inventor: Sidney J. Kaplan, (US)

(21) Appl. No.: 13/538,575

(22) Filed: Jun. 29, 2012

Related U.S. Application Data
(60) Provisional application No. 61/571,570, filed on Jun. 30, 2011.

(51) Int. Cl. G06F 19/00

(52) U.S. Cl. 702/125

(57) ABSTRACT

Employing RF or optical communication connecting links to oscilloscope probes—adds mobility and flexibility to oscilloscope test and measurement operation. Currently bound by cables to the oscilloscope control and display functions the probe systems are freed to communicate and send signal images over a wide range in local areas. The RF linking of unique address probe systems allows multiple individuals at distant test sites to participate in coordinated viewing and controlling test operations facilitating group and management cooperation. The test probe cable system adapted or replaced by an RF link is configured for the two general classes of oscilloscopes—the integrated bench oscilloscope instrument and the bifurcated oscilloscope instrument that employs a PC for display and control. Oscilloscope probes that are cable free enable the signal measurements to be collected conveniently—even from remote or otherwise inaccessible points.

### CROSS REFERENCE TO RELATED APPLICATIONS

This application is entitled to the benefit of Provisional Patent Application 61/571,570 filed 2011 Jun. 30

### BACKGROUND

1. Field of Invention

This invention relates to the field of general purpose test instruments for electronic and electrical system and product testing of their electrical signals. The test instruments involved are primarily oscilloscopes that relate to early 20 century devices that displayed repetitive oscillatory signals to visual images. Before modern electronic image devices the repetitive signal trace were presented optically. Modern oscilloscope systems have signals that are continually unique as well as repetitive and these can be digitally sampled stored in memory and displayed via digital processing systems such as the ubiquitous PC. While the conventional bench top scope still terminates analog signals and maintains all signal processing internally, there has evolved over the last decades a class of general purpose oscilloscopes called Digital Storage Oscilloscopes used efficiently for signal analog to digital conversion and processed signal information to be sent to an efficient PC system that has been programmed to control signal sampling and present oscilloscope images. The technical advantages stemming from the rapid advances in A/D conversion technology and great facility and cost effectiveness of PC technology has expanded the market for this class of Digital Storage Oscilloscope. This invention is designed to replace the wire and cable connection to the PC with data communication links thus freeing the relatively small Pod that terminates the analog probes allowing broad efficient use of this type of oscilloscope instrument that is not possible with this and conventional bench top oscilloscope without this invention.

2. Description of Prior Art

Oscilloscope applications generally are used for multiple purposes in all electronic or industrial applications that involve multiple electrical test applications and so the oscilloscope system are designed for large variations in operating capability involving; —high and low frequency measurement —signal information resolution —signal voltage range measurement capability —signal resolution relative to instrument noise thresholds —damage resistance from high voltage —number of simultaneous channel use —memory capability —interface capability to other instrumentation such as PC and recorders —display features, triggering capabilities, ease of use among other characteristics —all of which impact cost. There are some classes of oscilloscopes that have to do with some areas of special purpose application that require features that may elevate their cost relative to other systems. For example—in some high cost communication system application test features are required for the high gigahertz frequency range and very high speed data applications and may not be used in more conventional applications. There are also oscilloscopes that test low frequency signals for audio and industrial electrical applications.

Classes of Oscilloscopes Systems

The general oscilloscope application benefits from the utility of this invention. It may be viewed that there are two categories of oscilloscope operation and each involves signal monitoring and testing with a signal probe for which RF links can be applied to replace the conventional cable connecting links. The older oscilloscope category involves the conventional instrument contained in one enclosure where all functions are performed on the applied signal. This oscilloscope class evolved over a period of 80 years for the multiplicity of electrical and electronic signal testing applications. The other involves a “Bifurcated Digital Storage (or Sampling) Oscilloscope” where there is single channel or multiple channels in a specialized unit called a Pod that terminates the probe test cable connections. The Pod samples an analogue test signal digitally so that processing and some data storage can take place before being sent to the PC operating with an oscilloscope application program for signal display and set up. The PC only accepts digital data that must be set up and applied in a coordinated manner and these are set through the commanded control functions performed in the Pod.

The Oscilloscope Evolution

The oscilloscope, evolved over eighty years, provides a visual image of the dynamics of the electrical signal that is unparalleled in its use for the general purpose test and measurement of signals in electric and electronic systems. It was developed over the period since the 1930's and advanced with the electronic industry to form progressively complex laboratory instruments. They developed as laboratory bench top instruments initially with cathode ray tube displaying visual representations of electrical test signals from the system or unit under test. The market for oscilloscopes expanded with the electrical and electronic industry advances—leading to products of various complexity and sizes for laboratory use. Among the integrated units—some where of light weight and portable that are used for portable field work. More recently advances involved integrated color displays in the conventional oscilloscopes. Their diversity in application relates to the high frequency of the signal being tested as well as the high voltage levels of the signal.

The oscilloscope instruments are in general bulky and weighty and are fixed in a laboratory position requiring the UUT to be positioned within a short distance from the instrument test probe lead attachment to the oscilloscope. More recent manufactured units are smaller and lighter in weight as CRT's cathode ray tube displays are being replaced by LCD displays—but still adapted primarily for laboratory bench use. The unit under test must be brought within a short distance from the oscilloscope instrument—only tethered to the instrument by a test lead called a probe system involving a contact point (hand held or hooked in place) and a coaxial cable that is generally one or sometimes two or more meters in length. Longer cables introduce unacceptable signal loading and are not common.

In the current oscilloscope technology instrument—involving the multiple functions of control switches, the signal processing and display requires a relatively large test instrument. The test probe—generally one to two meters in length—defines the limit of distance that a user can connect to the unit under test, UUT.

### PATENT TECHNOLOGY BACKGROUND

Oscilloscopes are used to acquire, display and analyze electronic signal waveforms. RF or other optical propagation fields of communication (such as Infra-Red spectrum application) can be used as communication links on oscilloscope test probes—allowing remote operation at greater distances from the display instrument. This enhanced freedom of movement of the contacts of the oscilloscope probe systems is beneficial in laboratory areas and in field and production testing. Among other things the unbound test probe eliminates the need for cables that interfere with the physical process of manipulating the signal sensing with the oscilloscope on the unit under test, UUT. Other advantages involve flexibility and ease of use in minimizing the need for long test probes as well as among other things—reducing the effects of impedance loading from the signal probe contact on the unit under test.

The Conventional Integrated Oscilloscope

Conventional oscilloscopes, or “Integrated Oscilloscopes”, involve operation that integrates all functions in parallel multiple channels in a single enclosure test instrument. Individual analogue test signals are displayed in parallel channels in analogue form. In a conventional oscilloscope with internal digital operation the analog input signals are sampled and the sampled signals are displayed as well as stored in one instrument. Input signals are processed and scaled in parallel on one display for viewing the signal interactions. Digital scopes have memory capability that allows replaying stored signals.

Radio frequency or alternative IR infra-red optical spectrum communication technology identified in this invention—for this application—involve replacing the connection of the probe contact and coaxial cable terminations with communication links that transmit analog signal information from the scope probe over coaxial cable to individual channel inputs on the Integrated Oscilloscope.

A communication transceiver (analogue or digital format that linearly modulates the RF signal) with one or multiple channels can transmit the signal information with all its properties of level and bandwidth from the probe to the integrated instrument. The RF communication link provides advantages of testing a signal that is isolated from the instrument ground connection with its associated ground electrical noise and without the impediments of the need to operate with large coaxial connecting cable capacitance that loads the test signal.

Among several alternative analog or digital transducers modules at the probe and oscilloscope interfaces—a cost effective communication link will transfer signal from the reconstructed baseband after demodulation in a manner that reconstructs the signal with fidelity that is at least as good a signal as that of a conventional coaxial cable probe connection.

Recent Oscilloscope PC Application—the Bifurcated Oscilloscope

In the late 1990's the signal processing part of the oscilloscope was adapted to digital processor technology with analog to digital converters and memory storage and packaged in an external pod that sent signals by cable to a general purpose PC computer. The PC that operates with oscilloscope application software provides display of the received signal from the signal capture pod. The PC is used to send the commands to the pod. The capture pod is identified as a Pod in this patent application.

The bifurcated oscilloscope takes advantage of the cost effective PC systems that with an application program provides quality display capability and control interfaces. The PC operation processes only one signal at a time and has no interface to decode the test signal to a digital form. Therefore a second specialized unit called a Pod that is currently attached to the PC by a cable—samples test signals digitally. The Pod is used for simultaneous sampling the analog testing and storage of multiple signal information from the unit under test.

The Pod signal information is generally stored in a digital memory in the pod unit that does the sampling. The blocks of test signal data stored for each channel are sent to the PC in a sequenced multiplexed operation after the signal capture interval. If the multiple channel signals under test are of low frequency compared to the data transfer operation to the PC—then the signals may be multiplexed one sample at a time.

As the analog test signals on each channel are to be in digital format for the PC to process and display the test signal image—the Pod which operates with an A/D converter will also provide the memory buffering necessary for the pod to capture the samples on command from the processing system. The Pod (which generally contains an internal processor) that is attached to the PC is commanded to send the data information in the proper sequence to the PC. The cable that can carry the information is in digital format and the RF operation that replaces the physical cable will also be in digital format.

Oscilloscope control for adaptation to a multiplicity of controls that involve among others —adaptations for signal voltage level —frequency-triggering —periodicity of display —require menu and or mouse control on the PC set up by the application program. In instances in the field or production testing a touchpad control PC would be advantageous.

This invention reflects the use of RF digital device technology to replace the binding cable connections of the Pod cables (e.g. USB cables) to the PC. Such cables have formats and protocols that have been optimized for PC operation. RF transceivers that have been adapted for PC operation over the years can be applied to this application. They operate at high speeds communication links—and may be integrated for use in this invention because of their cost effectiveness.

### BACKGROUND

Oscilloscopes are used to acquire, analyze and display electronic signal waveforms. These electrical signal monitoring instruments adapt to the range of measurement of the signals from a device under test and display the signal level values as the signal varies with time on a selected display time base. The component of an oscilloscope system that contacts the device under test involves a metal contact probe attached to a cable for signal transfer to an oscilloscope instrument. Currently the length of the probe cable limits the distance the unit under test can be from the display control instrument. The display instrument is generally large and of considerable weight and not easily movable. Even in those cases where the display control is represented to be portable and of light weight—the display unit is still tethered by a probe cable. Also where the scope is brought to the unit under test—and the portable display might be held—there is still a cable attachment to the probe—that when there is any motion involved with the display—either for viewing or control—there is a tension and movement on probe cable that often dislodges or inhibits the probe contact with the unit under test.

In the case of a bifurcated oscilloscope system there is an individual intermediate oscilloscope stage involving a Pod that separately samples signals connected with another cable to a PC for display. There is bidirectional communications with designed error free signal transfer fidelity on this cable attachment. In this current standard situation the probe cable and the Pod cable both restrict the mobility of the test probe manipulation in contacting the unit under test.

These oscilloscope instruments are a combination of the Pod and the application software for a general purpose PC both making up a bifurcated oscilloscope operation. The complex mechanical controls used by the user for adapting the oscilloscope operation could then be in the form of menu or window control software in the PC and sent to the digital Pod over the same cable connection that sends the signal information sampled and captured by the Pod to the PC.

The Pod functions to sample the signal and also buffers the captured sample information. Display or control of the oscilloscope sampling functions is taken over by a PC application program. The PC is capable of very good quality display and offers a cost effective adapted alternative to a conventional specialized bench oscilloscope. The Pod is tethered to the versatile PC via Ethernet or a USB cable (or any developed standard for PC application). A USB cable can also provides power to the Pod.

Both the integrated instrument and the bifurcated Pod/PC instrument, provides only limited convenience of motion of the oscilloscope operation as it is bound and inhibited by a cable to the PC for instrument control and display.

Differences from Telemetry Operation

When data systems are formally set up to collect and monitor data in a variety of different specific applications they may also require communications over large distances. Such systems may be automotive—missile systems—oil or gas well drilling or even with medical instrumentation in operating room environments. These procedures may reference the communication application as telemetry. This invention is different in that it is designed to facilitate the general operation of oscilloscope systems for general multipurpose testing involving the use of probe contact and coaxial cable connections—to monitor electronic or electrical power signals in many areas such as industrial and electronic system operations as well as specialized high performance communication system and data system test applications. Telemetry devices are typically specialized products that transmit data on a timed basis or on the occurrence of an event, such as a pulse received from the meter being read or systems for implantable medical devices. They use radio frequency (RF) energy to enable bidirectional communication of data as for example that between the implantable medical device and an external programmer.

### SUMMARY

The cable attachments of the Pod of the class of Digital Storage Oscilloscope that involves a PC for oscilloscope control and display is replaced by a radio frequency or optical link. The integrated oscilloscope type probe attachments can also be replaced by a radio frequency or optical link.

### OBJECTS AND ADVANTAGES

This invention applies the technology of RF or optical system communication to the test operation for the purpose of freeing up the oscilloscope probe terminations from their being bound by wire or cable to control and display instrumentation. The controller display devices are often conveniently left in place and the probe system able to be moved and fastened in place at positions at great distances expanding the flexibility, mobility and ease of use of test signal monitoring. Moreover there may be more than one controller that can operate or view and command the testing. The RF unbound test operations allow multiple address labels that facilitates this capability. The RF linking of unique address probe systems allows multiple individuals at test sites to participate in coordinated viewing and controlling test operations facilitating group and management cooperation.

In addition the developing flexibility of the unbound system is promoted from the fact that the PC is continually being miniaturized improving portability, The form of the developing tablet PC is particularly useful as it is particularly easy to handle in signal testing. It is easily visualized that the user of a hand held tablet controller would find it more convenient in the oscilloscope application to have the test probe information relayed over a radio link.

Oscilloscope Testing—Free of Cable Connection Restrictions

This invention involves the evolved oscilloscope test and measurement systems with conventional operation and provides a means for allowing users to have the ultimate convenience in using small unconnected hand held probe device with no physical connection to the display instrument.

The unbound mobile oscilloscope instrument probe system is free to operate without a cable attachment by duplicating the operation of the cable attachments with communication links. The test signal information is sent from the normal probe and display instrument cable attachments replaced by a radio frequency channel. In some systems control information is sent to the probe-Pod where there is a bundle of complex of active signal interfaces and information storage. Without these wire or cable attachments and with the RF link the small physically unbound oscilloscope probe contact device can operate remotely (generally locally in the range of RF reliable reception in the range of 10 to 300 meters) at distances from the oscilloscope signal display depending on the method of RF communication system. The probe may be passive or integrated with a signal capture device for signal acquisition that is part of the oscilloscope system.

The metal probe in test operations fixes physically on a test point of the unit under test (UUT) to sample the electrical signal. The acquisition of test information with ultimate convenience is based on the use of and the integration of multiple adaptations from the high speed and reliability performance of technology evolved from the computer industry—that makes possible effective RF connections replacing the currently used cable connections.

Oscilloscopes are essential for research, development, and manufacturing of electronic devices. There are currently no patents found that are devoted to general purpose oscilloscope test and measurement technology that will facilitate their use by eliminating the cable attachments. Further the elimination of the need for cable shielding connection needed for high frequency applications—eliminates the cables large disruptive capacitance on the test probe signal contact. The cable is only needed to transfer the signal from a test probe in the one or two meter cable length providing a relatively narrow freedom of motion. Thus an important advantage of the mobile unbounded oscilloscope is that it facilitates operation at high frequency because of the elimination of high capacitance coaxial cable probe attachment loading.

Patents that Mention Wireless Linkage are Unrelated

Patents that reflect issues of wireless connectivity for probe devices are not related to general purpose test and measurement oscilloscope operation. Rather they focus on specialty probe signal communication in medical applications and automobile test and other special applications and even controls in use for telemetry applications. There are no patents that suggest application for the industry of general purpose oscilloscope

### DRAWINGS

FIG. 1 Digital Storage Oscilloscope PC System with RF Probe Pod Attachment

FIG. 2 Basic Integrated Oscilloscope Systems with Conventional Analog Signal Input with RF Connection

### LIST REFERENCE NUMERALS

1=Oscilloscope Pod Multi-channel-part of Bifurcated Oscilloscope
1a=Oscilloscope-remote Probe and attached interface with RF capability without need for probe cable
1b=Oscilloscope-remote Probe and attached interface with RF capability without need for probe cable
2=RF transceiver internally located in Multi-channel Pod link to PC, replaces wire connection. RF transceiver internally located in Probe-Pod
2a=RF transceiver internally located in single-channel Pod link to PC, replaces wire connection. RF transceiver internally located in Probe-Pod
2b=RF transceiver internally located in single-channel Pod link to single channel on scope input, replaces wire connection. RF transceiver internally located in Probe-Pod
3=Conventional oscilloscope probe and coaxial cable
3a=Oscilloscope probe with coaxial cable eliminated
3b=Oscilloscope probe with coaxial cable eliminated
4=Battery internally located in multi-channel Pod
4a=Battery internally located in single channel Pod
4b=Battery internally located in single channel Pod
5=Computer Control; PC Laptop or other variety of PC
5a=Integrated Computer Control; RF transceiver and controller that receives signal data from remote Probe Pod and converts the signal in digital format to continues original analogy signal format
6a=RF transceiver mounted to standard desktop PC port typically USB port
6b=RF transceiver system mounted to standard bench top analog input oscilloscope port, typically BNC connector, with signal processing that also converts transferred signal to analog format
7=Conventional Oscilloscope with analog input ports
8=deleted
9=Representation of electromagnetic radiations from transceivers for digital converted signals
10=an analog test signal
11=an analog test signal being probed
12=Signal testing on electrical device
13=Bench top typical oscilloscope with analog signal input
\

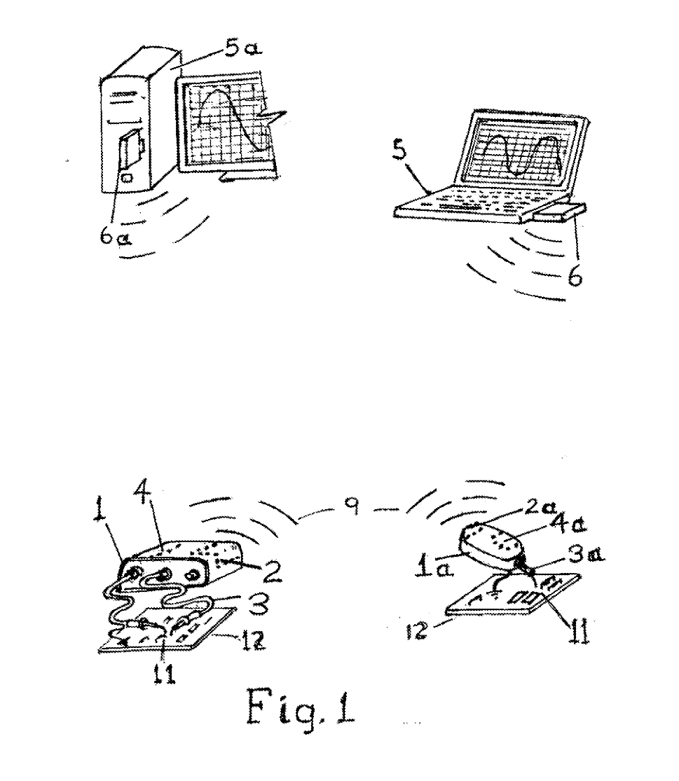

### DESCRIPTION FIG. 1 MAIN EMBODIMENT

The drawings represent the method by which a wire connection can be replaced by a RF or light frequency communication link. FIG. 1 shows a digital storage oscilloscope where an analog signal 11 on an electrical device 12 test being monitored is converted to digital samples in a Pod 1 or Pod 1a which has received signals from a probe in contact with the signal source 11. The Pod would have previously normally been connected to the PC control computer 5 via a cable that would have transferred the files of signal samples in a sequence to the PC 5. Rather the drawing of FIG. 1 shows the replacement of the connecting cable with an RF link that operates for the two classes of Pods 1 and 1a.

The main embodiment is shown in FIG. 1. The multichannel Pod 1 is equipped with a transmitter and receiver or transceiver 2 that is designed to communicate with transceiver 6 adapted to mount and interface electrically with the PC 5. The transceiver shown in dotted lines on the Pod 1 can internal to the enclosure of the Pod 1 and is shown in dotted line to illustrate one internal location area.

The transfer of the digitally sampled signal file of information is functionally similar to that which would have gone over a wired system but the Pod can now operate conveniently without wires over extended distances with a multiplicity of PC systems. The PC 5a also represented in FIG. 1 can be one of many PC system that can operate the same Pod 1 by using its unique address. PC 5a equipped with a transceiver 6a of the same type as transceiver 6.

The Pod 4a also shown in FIG. 1 as a single channel Pod where there is less of a need to attach an oscilloscope probe cable 3 as the unit is small and the probe tip can be mounted on the Pod body which would facilitate testing and mitigate the wire capacitive loading that a coaxial cable imparts,

The mobility and flexibility of the Pod communication link is an important advantage, accordingly a battery system may be included to provide power for the Pod operation when the testing is in remote locations. Previously the Pod might have received power from the wire connection. Accordingly a Battery 4 is shown in FIG. 1 as having an internal position in a dotted line designation.

The Pod 1a is shown to contact a test board 12 that has conventional analog signal levels 11. The Pod 1a has the transceiver 2a and battery located internally.

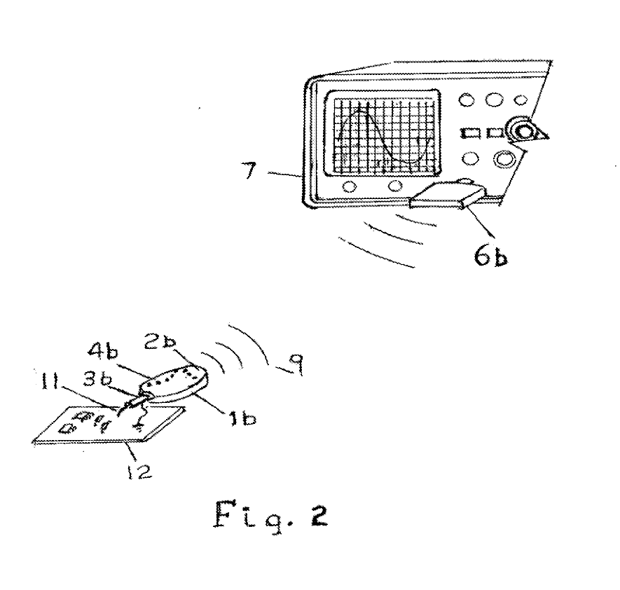

### FIG. 2 ADDITIONAL EMBODIMENT

FIG. 2 is another embodiment that is designed to function as by having an RF link between a probe contact and a more standard bench type analog scope that accepts analog signals at its input port. To take advantage of the mobility and convenience issue of the RF link of that shown in FIG. 1 a pod-transceiver 1b mounts to the probe 3b and a pod 6b with transceiver that also has limited computer control capability is applied to the input of the oscilloscope input port. The limitation of computer control is because the function of 6b is to primarily only act to present a continuing analog signal that is a copy of the signal at the distant probe. The computer controller is converted—so that the test digital samples from the Pod are decoded and converted to analog form. The amplitude of the original tested signal can now be applied to the analog scope either as a continuous signal or as impulses for display resolution. The Pod 1b is shown to contact a test board 12 that has conventional analog signal levels 11. The Pod 1b has the transceiver 2b and battery located internally.

\

### ADVANTAGES

This wireless oscilloscope invention that involves RF connection to the PC host application (display and control) makes significant improvements as the Pod can be spaced at any distance in the range of the local RF communication signal. To integrate the probe interface directly to the pod makes a completely cable free pod that can contact the unit under test with no encumbrance. The range of operation of the sampling pod depends on the local operational range of the RF technology employed which among other things; —involves modulation band width, power level, noise level resolution, coding, etc.

Probe Connections on a Single Pod

The Pod is a processing electronic unit that can be made small enough to be handled as an integrated probe when the contact point is joined to it. In this arrangement it allows the user to hold an oscilloscope contact point in hand with no cabling accepting control information from the PC and sends test signal information to the PC. The Pod can even be reconfigured by command from the PC or autonomously to adapt probe impedance/attenuator configuration appropriately for each test application.

In the case of the bifurcated oscilloscope systems the ultimate unattached instrument convenience occurs because of the elimination of two obtrusive binding wires on the Pod. One wire is to the standard probe and the other is to the display and control instrument. A third wire power wire would be needed for providing power to the active electronic elements on the sampling pod arrangement and therefore an integrated battery operation is required to mitigate need for such power connection. While power sources are ubiquitous—it is in the interest of optimum portability to eliminate any wire and cable connections by integrating a battery operation in the pod.

In the case of the PC in which the application program displays and controls the oscilloscope operations the PC might also be freed of power line restrictions for complete system portability. PC portability (battery operation) is ubiquitous and readily available in laptop, tablet and net book PC operation. This invention can therefore provide complete freedom of mobility in bifurcated oscilloscope operation.

Operation: FIG. 1

The operation of the Digital Storage type oscilloscope system of FIG. 1 with RF link connection between the Pod and the PC is functionally the same as that when a wire connection is made, while the same functional sequence of operation in applying a probe to a test point is made and digital samples are transmitted to the PC display, the one obvious concern might be that the RF data link on Pod 1 or 1a to PC 5 or 5a might not be as fast as the conventional speed of communication over a wire connection as for example a USB cable. In fact there is a variation in some of the different speeds of the standard PC RF communication links that might be employed in this application. While some of the speeds are as high as that a wire link over even large distances there are possibilities that some RF links while having slower speeds are more flexible and use less power. It is also a consideration that the sampling operation and the actual human interface for viewing the test signal is such that a slower speed RF link may not be the deciding factor in the choice of RF technology in most applications. There are considerations, not the least of which is human response time, which would make the selection of a lower speed link satisfactory.

The RF linking of unique address probe systems allows multiple individuals at distant test sites to participate in coordinated viewing and controlling test operations facilitating group and management cooperation

Operation: FIG. 2

The operation of the RF link for strictly developing a RF analog signal transmission link from the probe pod 4a to the analog input to a scope pod 8 is somewhat different then the system of FIG. 1. In its simplest form where there is no processing in the pod attached to the analog scope then the high frequency speed of response for the oscilloscope will be more favorable if the RF data speed is high and a good match for the speed of the A/D converter operation. Other consideration of this is that the fidelity of the signal and its dynamic range will depend on the manner that the probe-pod adapts to the signal level. Multiple alternatives exist to expand the range of performance of system by providing the probe pod with cognitive ability to adapt the signal range of operation for optimum performance and in a way communicate the signal level adaptation to the user so that the bench scope representations can be easy coordinated.

### CONCLUSIONS RAMIFICATIONS AND SCOPE

The Ramification of the expanded benefits of “UN-TETHERED OSCILLOSCOPE OPERATION” are extensive.
Quality testing of signals in a laboratory environment can be facilitated;—
   Environment that suite the restricted probing of test signals in close proximity to test instruments restricted by the limit of probe cable lengths.
   situations where the user must divide the attention to testing between instrument control and the care in probing the unit under test and concern for probe cable tangling or upsetting the electrical environment
   Tablet PC will allow quality signal display and touch control that is not fixed in place but can be carried without wire encumbrances.
   Compact probes integrated within short distances from signal processing makes it unnecessary to have long probe cable lengths that cause capacitance loading frequency degrading effects that can only be mitigated by signal attenuation by ten to one scaling.
Quality testing in remote environments can be facilitated;—
   Field testing where equipment attachments can be made without concern for control unit cables impairing the user by limiting the flexibility needed to have comfortable control of measurement actions.
   Multiple Control Users at multiple locations can participate in project testing engaging the groups multiple capabilities for consensus,
   Involved scheduled test operations can be accommodated by a user that will be required to be involved in other projects at different locations,
   Ability of Managers to observe test operations in real time.
Achieve a common base of Test Equipment
   Use the PC to Signal test images facilitating test image records keeping, promoting product performance analysis and quality control refinement.
Expanding RF standard low cost Technology Capability Open Opportunity for Test Equipment
   Enables giga frequency high bandwidth capability in local area regional testing
   Long distance access via internet and cell phone methods enable long distance user participation.
Low cost test Systems expand opportunities for machine to machine, M2M, technology
   Popular high volume use computer technology—can employed to expand test operations in high frequency miniature low cost systems. It is the multiplicity of standard digital high data rate communication links that are used for multiple purposes in short range communications that because of economy of scale yields low cost, small, low power modules that can be adapted to the probe oscilloscope application effectively and efficiently at even the highest bandwidths.
Expanding technical opportunities for higher performing test and measurement
   An intelligent probe pod can be called one which adapts to the common digital signal. This is an expanded improved feature from the human control that must select a standard integrated oscilloscope probe for appropriate voltage level which is often not known. The control may be autonomously performed by a common PC system or the microprocessor in the Pod.
   Ground wire isolation is a beneficial feature when Probe-Pod systems operate in an RF mode since common test instrument grounding can cause noise and isolation problems.
   Batteries are provided for unrestricted mobility. Elimination of power cords to test equipment requires battery power and provision for charging which can function by use of USB cables when the Probe in a cable attachment mode to the PC is made.
   There are many forms of communication operation that can be used to function as a communication link in place of cable connections in the oscilloscope configurations. The more common ones developed and refined to work with PC systems involve Zigbee, WiFI, Bluetooth and even WiMax. They each have particular advantages including range of operation and equipment complexity as well as cost. The RF Zigbee technology (802.15.4) technology (already tested on this invention) operates effectively over a distance 100 meters and remote control at distances the Zigbee transceiver can be adjusted for optimum power operation. Dedicated Short range Communication Service, DSRC, is intended for highly secure, high-speed wireless communication between vehicles operating on roads may be used
   Multiple-Single Channel Probe Systems. Triggering Operation Single channel probe operation unencumbered by cables may be required to operate with one or more single channel probe in a test operation that reqskaplanuires simultaneous display in time sequence. This capability is needed in standard oscilloscope operation to see the effects of simultaneous causal events on the electronic signals.
   Two or more channels in the same oscilloscope bifurcated Pod system that communicates with the PC over one RF channel will be able to transfer all the information on the separate Pod channels in time sequence. Cable attachments for many channels to one Pod may limit mobility. Operational flexibility can be enhanced by use of separate single channel units that operate over different RF frequencies but are triggered so that coordinated timing is maintained in viewing signal events.

I claim:

1. A method for providing oscilloscope probe signals with wire free operation using RF or light wave signal transmission to the oscilloscope control unit display. A Pod unit with test signal probe contacts which is a part of a digital storage oscilloscope employing a computer control for test signal information display and command is provided with mobility and multiple accesses to multiple test computer control units comprises:
(a) providing said Pod with a means of processing sampled signal data with memory and interface timing for the wire free transmission of signal said signal information as well as RF reception of command signal from said computer command processes,
(b) providing the means for the said computer oscilloscope control computer that comprises PC, tablet or specialized processors with signal timing and processing capability to adapt to the wire free said transmission system of the signal information to be received from the said pod as well as the command signals to be transmitted to the said pod,
(c) providing the means for said transmission system that replaces any connecting cable or wiring between said pod and said controller, were the communication system comprises such standard systems comprise Zigbee, Wi-Fi, Bluetooth or any non standard communication protocol,
(d) providing the said computer control a means to display command control of the said transmission system that control the said pod in establishing the timing and version of desired sampling operation,
(e) providing the said computer control a means to display the test signal timed sequence received over the said transmission system,
(f) providing a means for said computer control addressing each signal capture pod that allows the controller to uniquely control said pod transmission to receive said sampled data,
(g) providing a means for a plurality of said controller computers controller where each can individually address each one of said signal capture pods allowing control of selected and addressed said Pods enabling said signal data transmission to be received,
whereby said control and display computer can control said pod or pods and
command signal monitoring and display over a range that can be several hundred meters (depending on the transmitter recover used) that is a major improvement compared to the short distances that current cable attachments allow for probe systems tethered to oscilloscope control and display instruments, and
whereby the wire free probe attachments mitigate the need for long attachment wires and probe cables in use in laboratories.

2. The said Cable Free Oscilloscope Probe System of claim 1 has a means of a powering the said system with a battery system incorporated in said Pod that by making it unnecessary to attach the said Pod to a nearby power source where the battery system facilitates said system in mobility and freedom of use.

3. The said Cable Free Oscilloscope Probe System of claim 1 has a means of making an unbound probe cable system that can provide an analog test signal to any independent oscilloscope system by adding an analog conversion output of said computer control received said test signal and enabling the converted analog signal to be applied to the oscilloscope analog input.

4. A oscilloscope probe system that is cable and wire free uses RF or light wave signal transmission system enabling free unencumbered probes on a Pod unit of a bifurcated digital storage oscilloscope, (DSO), to have mobility and multiple accesses to multiple test control units comprising:
(h) said Pod that converts probe contact input analog signals to digital samples and store the signal data in memory under processor control for adapting the interface timing for the wire free transmission of said signal information as well as reception of command signal from said command processes,
(i) an oscilloscope computer control that comprises PC, tablet or specialized processors with signal timing and processing capability to provides a means to adapt to the said wire free transmission system of the said signal information to be received from the said Pod as well as the command signals to be transmitted to the said Pod,
(j) said transmission system that replaces any connecting cable or wiring between said pod and said controller computer comprises such standard systems comprise Zigbee, Wi-Fi, Bluetooth or any non standard communication protocol,
(k) said computer control displays command control of the said transmission system that provides a means to control the said pod in establishing the timing and selected type of the appropriate sampling,
(l) said control computer incorporates a display that presents the test signal representation in timed sequence as received and decoded over the said transmission system,
(m) said computer control addressing each said Pod provides a means to uniquely control said Pod transmission to receive said sampled data,
(n) the addressing system provides a means for a plurality of said computer controllers where each can individually address each one of said signal capture Pods allowing control of each selected and addressed said Pod enabling said signal data transmission to be received by each said control computer,
whereby said control computer can control said pod or pods and
command signal monitoring and display over a range that can be several hundred meters (depending on the transmitter recover used) providing a major improvement compared to the short distances that current cable attachments allow for probe systems tethered to oscilloscope control and display instruments, and
whereby the wire free probe attachments mitigate the need for long attachment wires and probe cables the oscilloscope use in laboratories is facilitated.

5. The said Cable Free Oscilloscope Probe System of claim 2 has a means of a powering the said system with a battery system incorporated in said pod that facilitate said system in mobility and freedom of use.

6. The said Cable Free Oscilloscope Probe System of claim 2 also contains an analog conversion output of said computer controller that receives said test signal making an unbound probe cable system that can provide an analog test signal to any independent oscilloscope system.
